(19) United States
(12) Patent Application Publication
(10) Pub. No.: US 2008/0172697 A1
(43) Pub. Date: Jul. 17, 2008

(54) PROGRAM RECORDING APPARATUS

(76) Inventors: Masato HANASHIMA, Hyogo (JP); Yasunori Naruse, Shiga (JP); Toshiaki Miyawaki, Osaka (JP); Kazuhide Yanase, Osaka (JP); Kentaro Hirao, Osaka (JP)

Correspondence Address: MCDERMOTT WILL & EMERY LLP, 600 13TH STREET, NW, WASHINGTON, DC, 20005-3096, US

(21) Appl. No.: 12/013,731

(22) Filed: Jan. 14, 2008

(30) Foreign Application Priority Data
Jan. 16, 2007 (JP) P.2007-007001
Oct. 12, 2007 (JP) P.2007-266777

(51) Int. Cl. G06F 13/00

(52) U.S. Cl. 725/46

(57) ABSTRACT

A program recording apparatus for recording a program transmitted in a transport stream, includes an information acquisition portion which acquires genre information about the program from each TS packet of transmitted transport stream data, a conversion portion which converts the transport stream data into data in a predetermined format, a recording portion which records the transport stream data or the data in the predetermined format on a record medium, a control portion which controls at least one of the information acquisition portion, the conversion portion and the recording portion, and a storage portion which stores profile data in which a recording format every genre is set. The control portion controls at least one of the information acquisition portion, the conversion portion and the recording portion based on the profile data when the genre information about the program acquired by the information acquisition portion is set in the profile data.

### BACKGROUND

The present invention relates to a program recording apparatus for automatically selecting a recording method desired by a user and recording a program with the recording method.

An apparatus for recording a television program (hereinafter simply called “a program”) transmitted by an MPEG-TS (MPEG Transport Stream) on a record medium records the program without converting the MPEG-TS or records the program by a recording format preset by a user every program. A user using the apparatus must set a desired recording format every program when the user wants to record the program by a recording format other than the predetermined recording format. However, work for setting the recording format every program becomes a burden on the user.

In the invention disclosed in JP-A-2000-13759, an information sending apparatus describes any of “information effective only at the time of viewing”, “information effective only at the time of picture recording and reproduction” and “information effective at the time of viewing and at the time of picture recording and reproduction” in SI (Service Information) including program information etc. defined by digital broadcasting standards as one of the program information, and an information receiving apparatus classifies the program information included in the SI and performs processing.

However, in both of the apparatus and the related technique disclosed in JP-A-2000-13759, a program cannot be recorded automatically by a recording format desired by a user according to the contents of the program. A user must set a desired recording format every program when the user wants to record the program by a recording format other than a predetermined recording format.

### SUMMARY

An object of the invention is to provide a program recording apparatus for automatically selecting a recording method desired by a user and recording a program.

The invention provides a program recording apparatus for recording a program transmitted in a transport stream, comprising:

an information acquisition portion which acquires genre information about the program from each TS packet of transmitted transport stream data,

a conversion portion which converts the transport stream data into data in a predetermined format,

a recording portion which records the transport stream data or the data in the predetermined format on a record medium,

a control portion which controls at least one of the information acquisition portion, the conversion portion and the recording portion, and

a storage portion which stores profile data in which a recording format every genre is set,

wherein the control portion controls at least one of the information acquisition portion, the conversion portion and the recording portion based on the profile data when the genre information about the program acquired by the information acquisition portion is set in the profile data.

In the program recording apparatus, a recording format every genre set in the profile data includes at least one of a kind of the record medium and a recording mode indicating a bit rate.

In the program recording apparatus, the conversion portion converts a bit rate at recording of the transport stream data.

In the program recording apparatus, the conversion portion converts the transport stream data into the data in a program stream.

In the program recording apparatus, the information acquisition portion distinguishes a kind of an elementary stream from an identifier assigned to a TS packet of the elementary stream constructing the transport stream and outputs a necessary elementary stream. A recording format every genre set in the profile data includes a kind of the elementary stream.

In the program recording apparatus, when the information acquisition portion acquires from the transport stream data the genre information which is set in the profile data as a user does not want to record, the recording portion does not make recording on the record medium.

In the program recording apparatus, the recording portion selects only a program of a genre matching with the profile data and records the selected program on the record medium when the transport stream data has multichannel data.

According to a program recording apparatus of the invention, a recording method desired by a user can be automatically selected to record a program.

### BRIEF DESCRIPTION OF THE DRAWINGS

The above objects and advantages of the present invention will become more apparent by describing in detail preferred exemplary embodiments thereof with reference to the accompanying drawings, wherein:

FIG. 1 is a block diagram showing a program recording apparatus according to a first embodiment;

FIG. 2 is a diagram showing a storage structure of profile data used in the first embodiment;

FIG. 3 is a flowchart showing an action of the program recording apparatus according to the first embodiment;

FIG. 4 is a flowchart showing an action of a program recording apparatus according to a second embodiment;

FIG. 5 is a flowchart showing an action of a program recording apparatus according to a third embodiment;

FIG. 6 is a flowchart showing an action of a program recording apparatus according to a fourth embodiment;

FIG. 7 is a flowchart showing an action of a program recording apparatus according to a fifth embodiment;

FIG. 8 is a diagram showing a storage structure of profile data used in the fifth embodiment;

FIG. 9 is a flowchart showing an action of a program recording apparatus according to a sixth embodiment;

FIG. 10 is a diagram showing a storage structure of profile data used in the sixth embodiment; and

FIG. 11 is a flowchart showing an action of a program recording apparatus of a seventh embodiment.

### DETAILED DESCRIPTION OF EXEMPLARY EMBODIMENTS

Embodiments of the invention will hereinafter be described with reference to the drawings. A program recording apparatus of the embodiments hereinafter described records a television program (hereinafter simply called “a program”) transmitted by an MPEG-TS (MPEG Transport Stream) on a record medium.

### First Embodiment

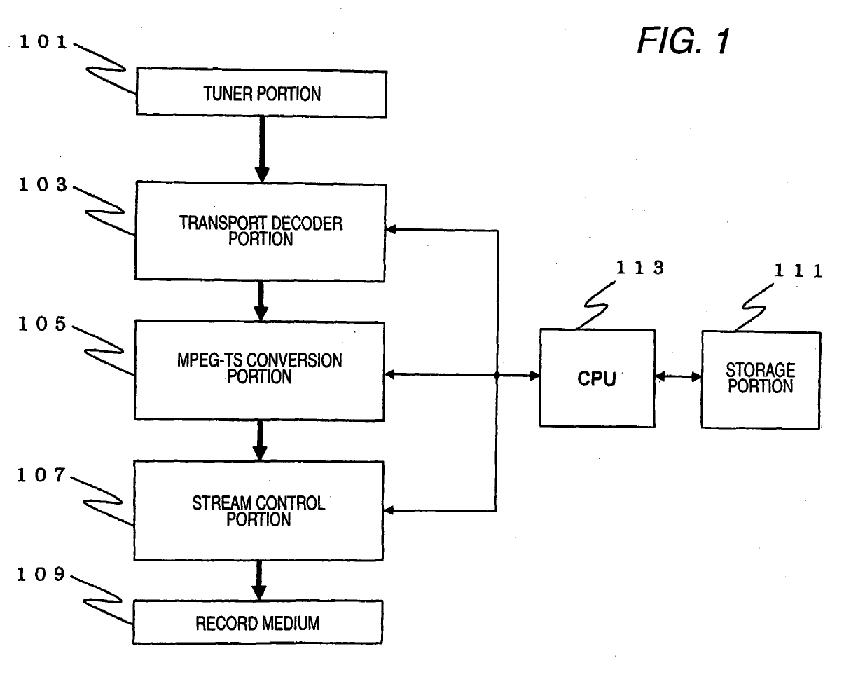

FIG. 1 is a block diagram showing a program recording apparatus of a first embodiment. The program recording apparatus of the first embodiment includes a tuner portion 101, a transport decoder portion 103, an MPEG-TS conversion portion 105, a stream control portion 107, a record medium 109, a storage portion 111 and a CPU 113 as shown in FIG. 1.

The tuner portion 101 receives MPEG-TS (MPEG Transport Stream) data transmitted from a broadcast station etc. The MPEG-TS data is a TS packet string into which data such as video, sound and text is subdivided. A packet header having a role of a tag of each TS packet is assigned to the TS packet. The packet header includes a packet identifier (PID) representing a kind of the TS packet. Each data stream of video, sound, etc. is transmitted by a TS packet having a unique PID. As a result of this, a kind of each TS packet can be identified even when plural kinds of TS packets are mixed in one MPEG-TS data.

In addition, the MPEG-TS is designed by assuming transmission through a transmission line in which an error may occur. On the other hand, an MPEG-PS (MPEG Program Stream) is designed by assuming that the MPEG-PS is handled in an environment with a low possibility that an error of reading and writing of data between record media etc. occurs. In digital broadcasting, a poor transmission environment must also be considered, so that the MPEG-TS is used.

The transport decoder portion 103 acquires SI (Service Information) including program information etc. from each TS packet of the MPEG-TS data. The MPEG-TS conversion portion 105 converts the MPEG-TS data received by the tuner portion 101 into a format instructed from the CPU 113. The MPEG-TS conversion portion 105 converts the MPEG-TS data into, for example, MPEG-PS data. The stream control portion 107 records data in which the format is converted by the MPEG-TS conversion portion 105 on the record medium 109. The record medium 109 is a hard disk (HDD), a DVD, a memory card, etc.

The storage portion 111 stores profile data preset by a user. Details of the profile data will be described below. In addition, data stored in the storage portion 111 is rewritable and a user can edit the profile data. The CPU 113 controls the transport decoder portion 103, the MPEG-TS conversion portion 105 and the stream control portion 107. Also, the CPU 113 determines a record medium of a record destination and a recording mode of a program transmitted by the MPEG-TS based on the profile data stored in the storage portion 111 and genre information about the program indicated by an EIT (Event Information Table) included in the SI acquired by the transport decoder portion 103.

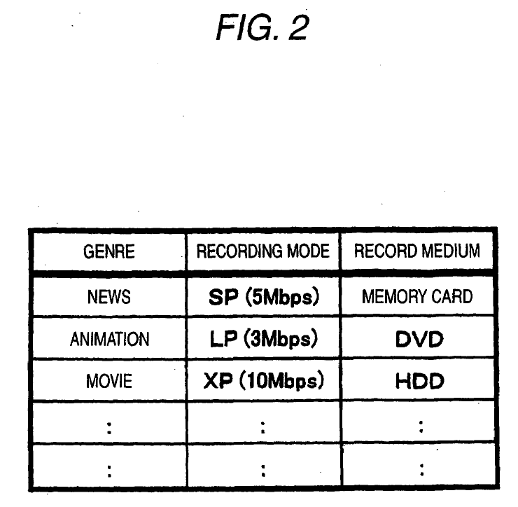

FIG. 2 is a diagram showing a storage structure of profile data used in the first embodiment. In the profile data shown in FIG. 2, a recording mode (bit rate) and a record medium are specified every genre. In an example shown in FIG. 2, in a news program, the recording mode is specified in an SP mode (5 Mbps) and the record medium 109 is specified in a memory card. Also, in an animation program, the recording mode is specified in an LP mode (3 Mbps) and the record medium 109 is specified in a DVD. Also, in a movie program, the recording mode is specified in an XP mode (10 Mbps) and the record medium 109 is specified in a hard disk (HDD).

In addition, a genre of a program may be classified into categories such as a large classification or a middle classification according to the contents of the program. As the large classification, rough genres of “news”, “animation”, “movie”, etc. are set and as the middle classification, for example, when the large classification is “movie”, one genre of the large classification is further classified into “foreign movie”, “Japanese movie”, etc. In terrestrial digital television broadcasting, the SI includes 4-bit information indicating the large classification and 4-bit information indicating the middle classification. As a result of this, the genre of the program can be classified into 16 kinds of large classification and 16 kinds of middle classification, that is, 16 times 16=256 kinds (including undefined classifications) at a maximum. The profile data shown in FIG. 2 does not correspond to stepwise classification, but may correspond to the stepwise classification of the large classification, the middle classification, etc. described above.

In the case of recording a news program transmitted by the MPEG-TS when the profile data shown in FIG. 2 is stored in the storage portion 111, the CPU 113 decides that the news program is recorded on the memory card (record medium 109) in the SP mode (5 Mbps) based on the profile data. The CPU 113 controls the MPEG-TS conversion portion 105 and the stream control portion 107 based on the decision. In addition, when a picture recording mode corresponding to a genre of the recorded program is not set in the profile data, the CPU 113 controls the MPEG-TS conversion portion 105 and the stream control portion 107 so as to record the new program received by the tuner portion 101 without converting a format of the MPEG-TS. Also, when a record medium corresponding to a genre of the recorded program is not set in the profile data, the CPU 113 makes recording on a predetermined record medium (for example, a hard disk (HDD)).

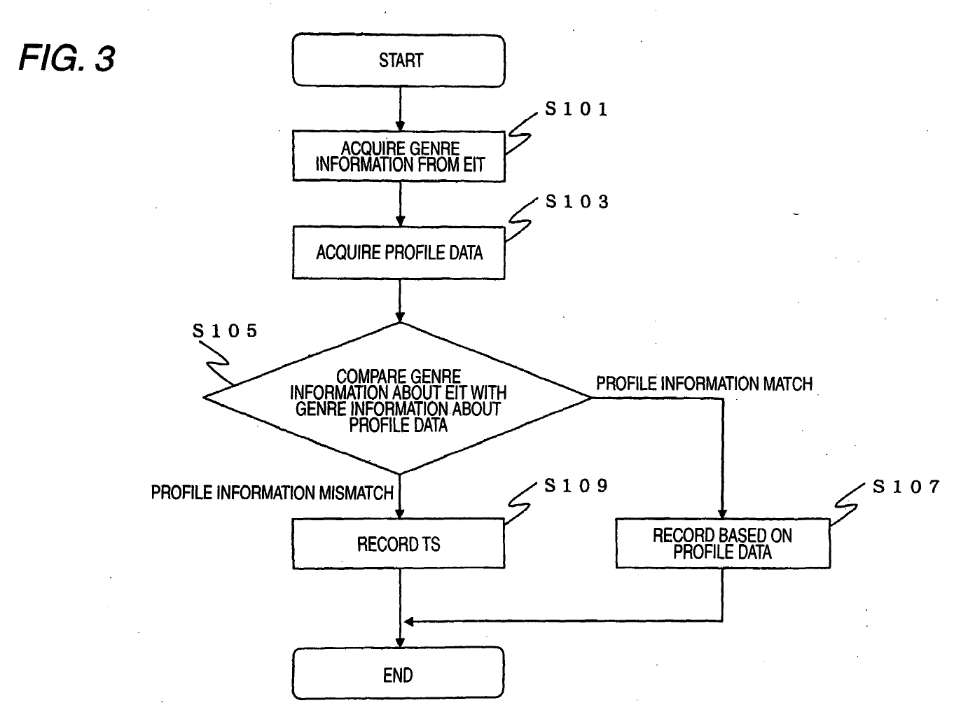

FIG. 3 is a flowchart showing an action of the program recording apparatus of the first embodiment. As shown in FIG. 3, in step S101, the CPU 113 acquires genre information about a program from an EIT included in SI acquired by the transport decoder portion 103 from MPEG-TS data received by the tuner portion 101. In step S103, the CPU 113 acquires profile data from the storage portion 111. In step S105, the genre information about the program is compared with the profile data. When the genre information about the program is set in the profile data (profile information match), the flowchart proceeds to step S107. When the genre information about the program is not set in the profile data (profile information mismatch), the flowchart proceeds to step S109.

In step S107, the CPU 113 controls the MPEG-TS conversion portion 105 and the stream control portion 107 so as to record the program on a corresponding record medium in a corresponding recording mode based on the profile data. On the other hand, in step S109, the MPEG-TS conversion portion 105 and the stream control portion 107 are controlled so as to record the program received by the tuner portion 101 on a predetermined record medium (for example, a HDD) without converting a format of the MPEG-TS.

As described above, according to the first embodiment, the recording format desired by a user can be automatically selected to record the program.

### Second Embodiment

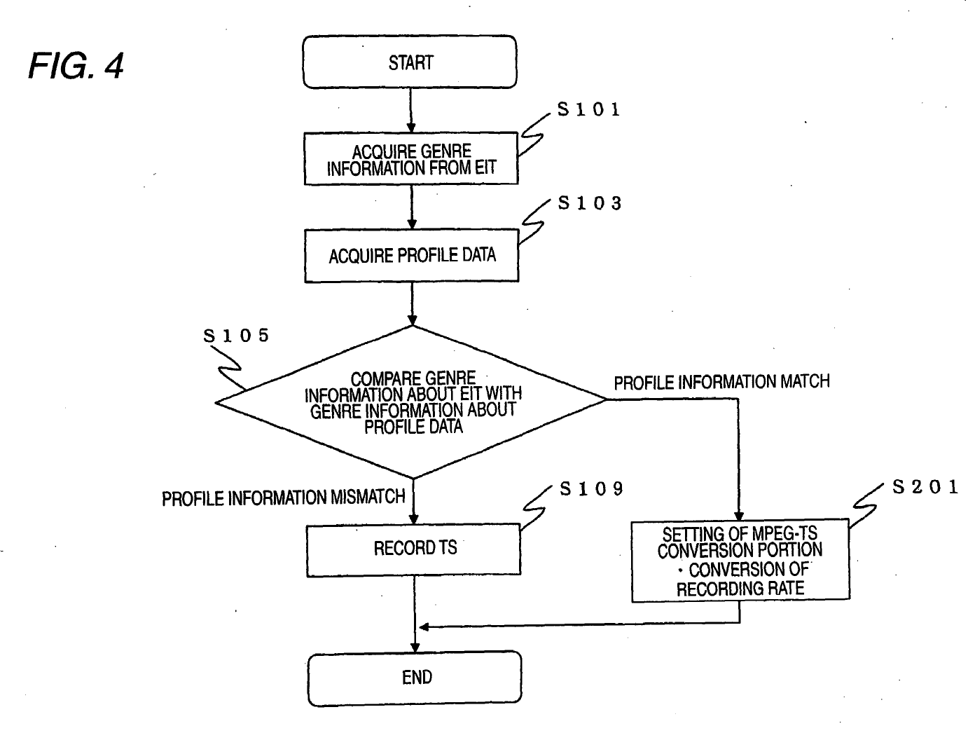

A second embodiment differs from the first embodiment in an action at the time when profile information matches. The second embodiment is similar to the first embodiment except for this respect and in FIG. 4, the same reference numerals are assigned to steps common to those of FIG. 1. FIG. 4 is a flowchart showing an action of a program recording apparatus of the second embodiment. As shown in FIG. 4, in step S105, genre information about a program is compared with genre information about profile data, and when the genre information about the program is set in the profile data (profile information match), the flowchart proceeds to step S201.

In step S201, the CPU 113 controls the MPEG-TS conversion portion 105 so as to be converted into a bit rate of a corresponding recording mode based on the profile data. In the present embodiment thus, the recording mode of the MPEG-TS conversion portion 105 is only set and a format of data sent from the MPEG-TS conversion portion 105 to the stream control portion 107 is the MPEG-TS and MPEG-TS data is also recorded on the record medium 109.

As described above, according to the second embodiment, conversion from the MPEG-TS into another format is not made, so that it is unnecessary to manage streams of plural formats. In addition, a configuration of the program recording apparatus of the second embodiment is substantially the same as the configuration of the program recording apparatus of the first embodiment, so that the description is omitted.

### Third Embodiment

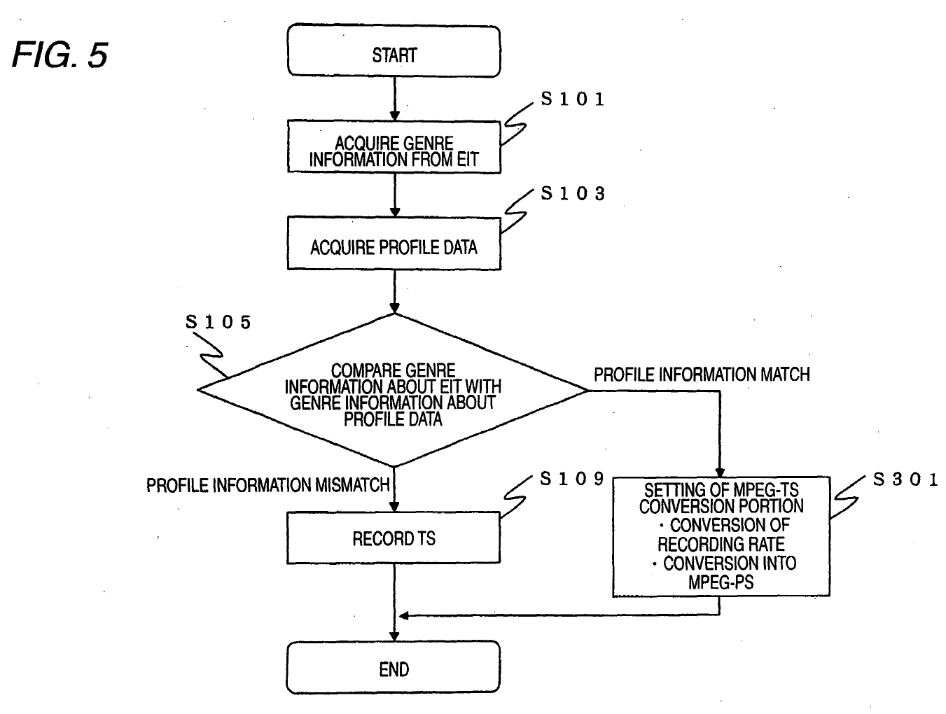

A third embodiment differs from the first embodiment in an action at the time when profile information matches. The third embodiment is similar to the first embodiment except for this respect and in FIG. 5, the same reference numerals are assigned to steps common to those of FIG. 1. FIG. 5 is a flowchart showing an action of a program recording apparatus of the third embodiment. As shown in FIG. 5, in step S105, genre information about a program is compared with genre information about profile data, and when the genre information about the program is set in the profile data (profile information match), the flowchart proceeds to step S301.

In step S301, the CPU 113 controls the MPEG-TS conversion portion 105 so as to be converted from an MPEG-TS into an MPEG-PS and be converted into a bit rate of a corresponding recording mode based on the profile data. In the present embodiment thus, a format of data sent from the MPEG-TS conversion portion 105 to the stream control portion 107 is the MPEG-PS and MPEG-PS data is recorded on the record medium 109.

As described above, according to the third embodiment, in the case of satisfying a condition, the data is converted from the MPEG-TS into the MPEG-PS and is recorded on the record medium, so that the data can be recorded in a format compliant with VR standards or Video standards. In addition, a configuration of the program recording apparatus of the third embodiment is substantially the same as the configuration of the program recording apparatus of the first embodiment, so that the description is omitted.

### Fourth Embodiment

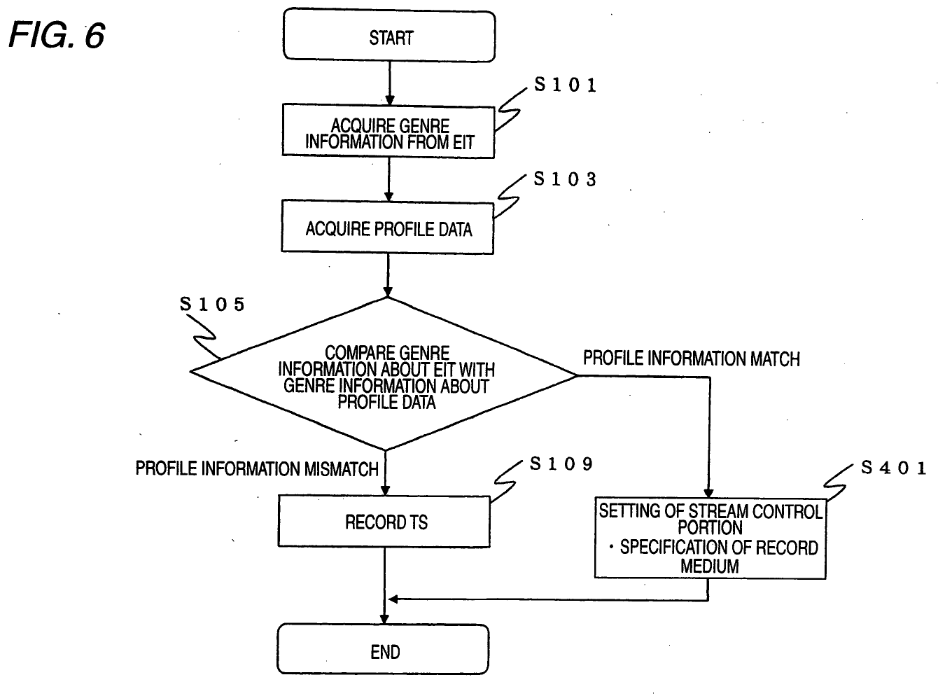

A fourth embodiment differs from the first embodiment in an action at the time when profile information matches. The fourth embodiment is similar to the first embodiment except for this respect and in FIG. 6, the same reference numerals are assigned to steps common to those of FIG. 1. FIG. 6 is a flowchart showing an action of a program recording apparatus of the fourth embodiment. As shown in FIG. 6, in step S105, genre information about a program is compared with genre information about profile data, and when the genre information about the program is set in the profile data (profile information match), the flowchart proceeds to step S401.

In step S401, the CPU 113 controls the stream control portion 107 so as to be recorded on a corresponding record medium based on the profile data. In the present embodiment thus, the record medium of a record destination is only set and a format of data sent from the MPEG-TS conversion portion 105 to the stream control portion 107 is the MPEG-TS.

As described above, according to the fourth embodiment, the data can be automatically recorded on a desired record medium according to a genre of a program. In addition, a configuration of the program recording apparatus of the fourth embodiment is substantially the same as the configuration of the program recording apparatus of the first embodiment, so that the description is omitted.

### Fifth Embodiment

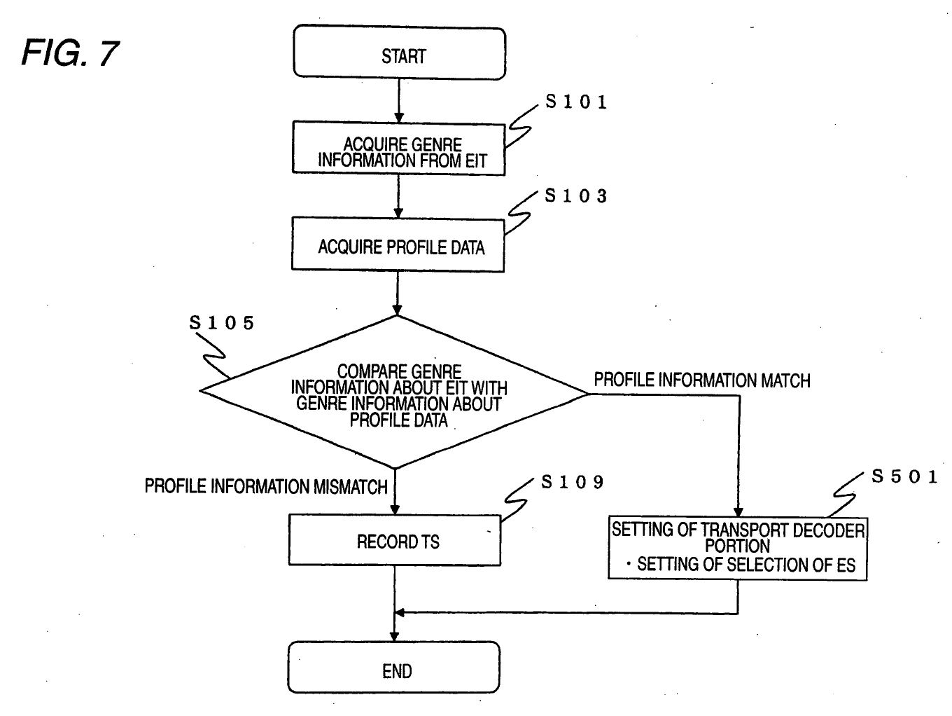

A fifth embodiment differs from the first embodiment in an action at the time when profile information matches. The fifth embodiment is similar to the first embodiment except for this respect and in FIG. 7, the same reference numerals are assigned to steps common to those of FIG. 1. FIG. 7 is a flowchart showing an action of a program recording apparatus of the fifth embodiment. As shown in FIG. 7, in step S105, genre information about a program is compared with genre information about profile data, and when the genre information about the program is set in the profile data (profile information match), the flowchart proceeds to step S501.

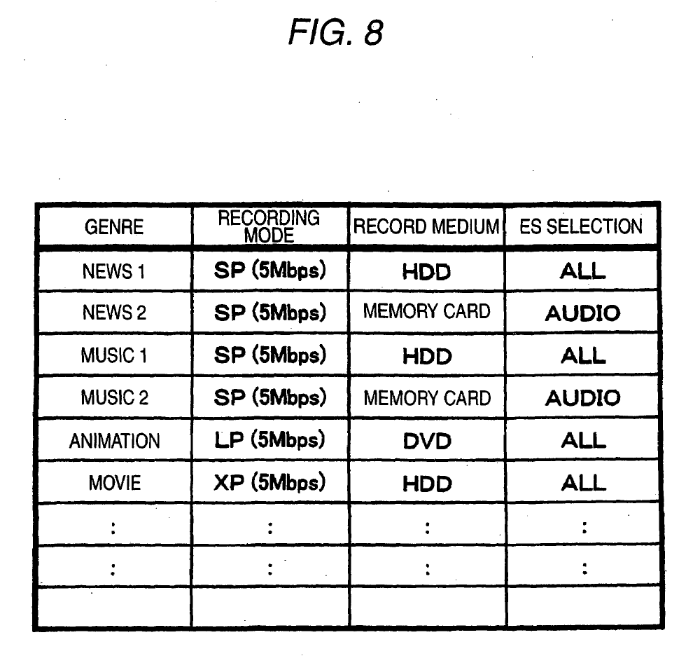

In step S501, the CPU 113 also controls the transport decoder portion 103 in addition to the MPEG-TS conversion portion 105 and the stream control portion 107 described in the first embodiment based on the profile data. FIG. 8 is a diagram showing a storage structure of profile data used in the fifth embodiment. In the profile data shown in FIG. 8, a recording mode and a record medium are specified every genre, and a kind of ES (Elementary Stream) selected every genre is specified. In an example shown in FIG. 8, a news 1 program is set so that the recording mode is specified in an SP mode (5 Mbps) and the record medium 109 is specified in an HDD and all the ESs are selected. On the other hand, a news 2 program is set so that the recording mode is specified in an SP mode (5 Mbps) and the record medium 109 is specified in a memory card and the ES of audio (only sound) is selected.

In the case of recording a program belonging to a genre of the news 2 transmitted by an MPEG-TS when the profile data shown in FIG. 8 is stored in the storage portion 111, the CPU 113 controls the transport decoder portion 103 so as to select and output only an audio ES of the ESs of the program based on the profile data. The transport decoder portion 103 distinguishes kinds (video, audio, etc.) of ES from a PID (packet identifier) assigned to a TS packet included in the ES constructing a transport stream, and outputs only a necessary ES. Also, the transport decoder portion 103 deletes an unnecessary PID from a PMT (Program Map Table).

### Sixth Embodiment

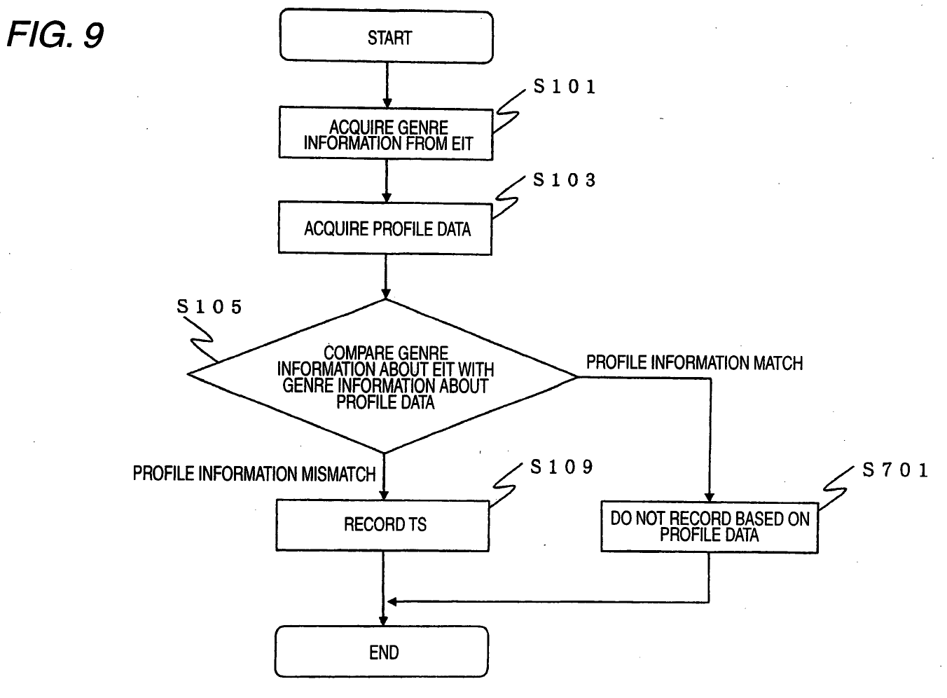

A sixth embodiment differs from the first embodiment in an action at the time when profile information matches. The sixth embodiment is similar to the first embodiment except for this respect and in FIG. 9, the same reference numerals are assigned to steps common to those of FIG. 1. FIG. 9 is a flowchart showing an action of a program recording apparatus of the sixth embodiment. As shown in FIG. 9, in step S105, genre information about a program is compared with genre information about profile data, and when the genre information about the program is set in the profile data (profile information match), the flowchart proceeds to step S701.

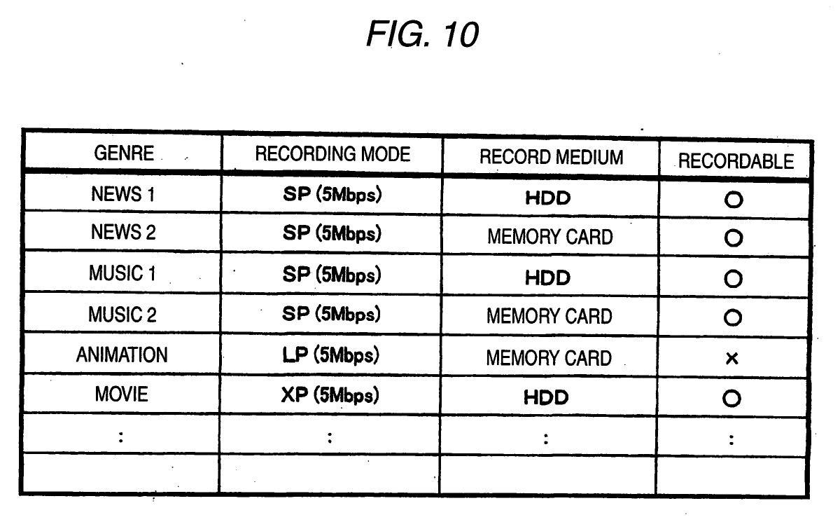

In step S701, the CPU 113 controls the stream control portion 107 described in the first embodiment based on the profile data. FIG. 10 is a diagram showing a storage structure of profile data used in the sixth embodiment. In the profile data shown in FIG. 10, a recording mode and a record medium are specified every genre, and recordable information selected every genre is specified. In an example shown in FIG. 10, a news 1 program is set so that the recording mode is specified in an SP mode (5 Mbps) and the record medium 109 is specified in an HDD and recording is enabled. On the other hand, animation is set so that the recording mode is specified in an LP mode (5 Mbps) and the record medium 109 is specified in a memory card and recording is disabled.

In the case of recording a program belonging to a genre of the animation transmitted by an MPEG-TS when the profile data shown in FIG. 10 is stored in the storage portion 111, the CPU 113 controls the stream control portion 107 so as not to record the program based on the profile data.

As described above, according to the sixth embodiment, only the data of a kind which may be recorded can be recorded on a record medium. In addition, a configuration of the program recording apparatus of the sixth embodiment is substantially the same as the configuration of the program recording apparatus of the first embodiment, so that the description is omitted.

### Seventh Embodiment

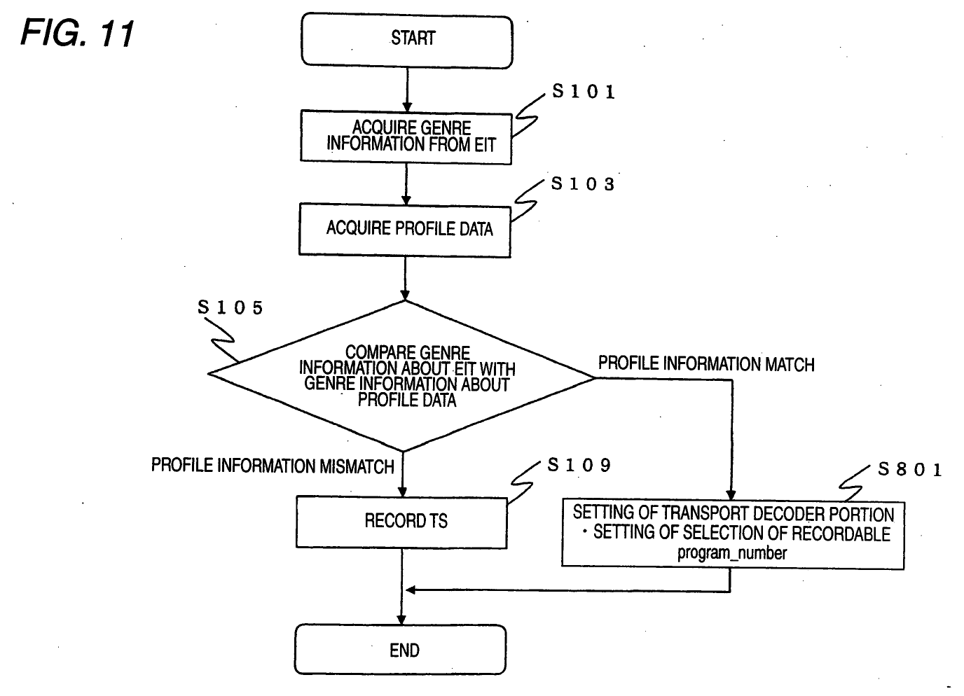

A seventh embodiment differs from the first embodiment in an action at the time when profile information matches. The seventh embodiment is similar to the first embodiment except for this respect and in FIG. 11, the same reference numerals are assigned to steps common to those of FIG. 1. FIG. 11 is a flowchart showing an action of a program recording apparatus of the seventh embodiment. As shown in FIG. 11, in step S105, genre information about a program is compared with genre information about profile data, and when the genre information about the program is set in the profile data (profile information match), the flowchart proceeds to step S801.

In step S801, the CPU 113 controls the transport decoder portion 103 so as to extract partial MPEG-TS data to record only a program of a genre matching with genre information about profile data in multichannel broadcasting based on the profile data. In the present embodiment thus, only the genre which wants to be recorded in a multichannel program can be outputted from the transport decoder portion 103.

As described above, according to the seventh embodiment, only the data of a kind which may be recorded can be recorded on a record medium. In addition, a configuration of the program recording apparatus of the seventh embodiment is substantially the same as the configuration of the program recording apparatus of the first embodiment, so that the description is omitted.

A program recording apparatus according to the invention is useful as a data recording apparatus etc. for automatically selecting a recording method desired by a user and recording a program.

What is claimed is:

1. A program recording apparatus for recording a program transmitted in a transport stream, comprising:
an information acquisition portion which acquires genre information about the program from each TS packet of transmitted transport stream data;
a conversion portion which converts the transport stream data into data in a predetermined format;
a recording portion which records the transport stream data or the data in the predetermined format on a record medium;
a control portion which controls at least one of the information acquisition portion, the conversion portion and the recording portion; and
a storage portion which stores profile data in which a recording format every genre is set,
wherein the control portion controls at least one of the information acquisition portion, the conversion portion and the recording portion based on the profile data when the genre information about the program acquired by the information acquisition portion is set in the profile data.

2. The program recording apparatus according to claim 1, wherein a recording format every genre set in the profile data includes at least one of a kind of the record medium and a recording mode indicating a bit rate.

3. The program recording apparatus according to claim 1, wherein the conversion portion converts a bit rate at recording of the transport stream data.

4. The program recording apparatus according to claim 1, wherein the conversion portion converts the transport stream data into the data in a program stream.

5. The program recording apparatus according to claim 1, wherein the information acquisition portion distinguishes a kind of an elementary stream from an identifier assigned to a TS packet of the elementary stream constructing the transport stream and outputs a necessary elementary stream; and
wherein a recording format every genre set in the profile data includes a kind of the elementary stream.

6. The program recording apparatus according to claim 1, wherein when the information acquisition portion acquires from the transport stream data the genre information which is set in the profile data as a user does not want to record, the recording portion does not make recording on the record medium.

7. The program recording apparatus according to claim 5, wherein the recording portion selects only a program of a genre matching with the profile data and records the selected program on the record medium when the transport stream data has multichannel data.
